(19) United States
(12) Patent Application Publication
(10) Pub. No.: US 2025/0353423 A1
(43) Pub. Date: Nov. 20, 2025

(54) COVER FOR A DUMP BED OF A VEHICLE AND VEHICLE HAVING SAME

(71) Applicant: American Metal Works, LLC, Piketon, OH (US)

(72) Inventor: Billy Lavern GLASS, Piketon, OH (US)

(73) Assignee: American Metal Works, LLC, Piketon, OH (US)

(21) Appl. No.: 19/210,558

(22) Filed: May 16, 2025

Related U.S. Application Data
(60) Provisional application No. 63/648,757, filed on May 17, 2024.
(60) Provisional application No. 63/659,524, filed on Jun. 13, 2024.
(60) Provisional application No. 63/729,615, filed on Dec. 9, 2024.

(51) Int. Cl. B60P 1/28; B60P 7/02

(52) U.S. Cl. CPC B60P 1/286; B60P 7/02

(57) ABSTRACT

Covers for a dump bed of a vehicle have a skeleton of longitudinal side beams having a transverse rib extending therebetween, a head beam, and a tail beam. The skeleton can have a pair of tyne pockets at each of the sides and a cover material defining a closed top with terminal ends of each pair of the tyne pockets exposed. The skeleton can have hinges and hydraulic arms each configured to connect to a dump bed. The hydraulic arms are configured to operatively connect to a vehicle hydraulic system to open and close the cover relative to the dump bed of the vehicle. The generally parallel longitudinal side beams are spaced apart a distance to align with the elongate sides of the dump bed and have sealing material connected thereto and to the head beam and tail beam to sealing engage surfaces of the dump bed.

### TECHNICAL FIELD

This application relates to a cover for a dump bed of a vehicle, more particularly, a cover that seals a dump bed that is designated to transport hazardous materials/debris with no material loss during transit.

### BACKGROUND

Hazardous materials need to be handled carefully and transported to an appropriate waste site, such as building materials from a prior manufacturing site for hazardous materials. To comply with regulations such materials are to be transported while covered such that no dust can escape from the materials during transport. The standard method is to load a dump truck and then, using manual labor, cover the load with a tarp which is strapped down to the truck. This is referred to as a tarping station. A tarping station is required at the site be remediated and at the waste site and each need a plurality of workers to handle the tarp and the straps. The tarp must be removed at the waste site and after the load has been deposited, the bed must again be covered with the tarp and secured by the plurality of workers for the truck to return to the original site to be filled again. No residual dust in the bed can escape into the air on the return trip. The use of tarps puts a constraint on the size of the dump bed used for the above hazardous material transport as well as being labor intensive.

There is a need for a cover for the bed of the vehicle suitable for larger dump beds and that eliminates the need to have tarping stations that utilize a plurality of workers.

### SUMMARY

In all aspects, covers for a dump bed of a vehicle are disclosed herein. The covers includes a skeleton having generally parallel longitudinal side beams with a transverse rib extending therebetween, a head beam, a tail beam, and a pair of tyne pockets at each of the sides. The longitudinal side beams are spaced apart a distance to align with the elongate sides of the dump bed. A cover material is connected to the skeleton and defines a closed top surface with the terminal ends of each pair of the tyne pockets exposed. The cover has a sealing material connected to each of the side beams, head beam, and tail beam configured to sealing engage surfaces of the dump bed. Each of the longitudinal side beams have a longitudinal flange extending downward from the outside surface thereof. The longitudinal flange is angled outward away from the main body of the cover to define an overhang about an exterior rim of the dump bed. The pair of tyne pockets can be formed by a pair of spaced apart transverse beams, wherein opposite end of each transverse beam define one of the tyne pockets on opposing sides of the cover. The cover can have exterior corners at each end of the tail beam.

In one embodiment, the head beam comprises a left post and a right post.

In one embodiment, the skeleton includes one or more longitudinal rails positioned proximately to the tail beam and configured for a tailgate of the dump bed to slide thereagainst under the skeleton to lift the cover. The longitudinal rails can extend from the tail beam.

In all embodiments, the cover can include one or more hinges configured to connect to a dump bed. In some embodiments, the cover includes one or more hydraulic arms connected thereto and having a free end configured to be anchored to the dump bed. The hydraulic arm(s) are configured to hydraulically connect to a vehicle hydraulic system and to operatively open and close the cover relative to the dump bed of the vehicle.

In another aspect, covers for a dump bed of a vehicle are disclosed herein that include a skeleton having side beams having a transverse rib extending therebetween, a head beam, a tail beam. The side beams are spaced apart a distance to align with the elongate sides of the dump bed. A cover material is connected to the skeleton to define a closed surface. The cover has a scaling material connected to each of the side beams, head beam, and tail beam configured to scaling engage surfaces of the dump bed. Each of the longitudinal side beams have a longitudinal flange extending downward from the outside surface thereof. The cover has one or more hinges configured to connect to a dump bed, and has one or more hydraulic arms connected thereto with a free end configured to be anchored to the dump bed. The hydraulic arm(s) are configured to hydraulically connect to a vehicle hydraulic system and to operatively open and close the cover relative to the dump bed of the vehicle. Each of the longitudinal side beams have a longitudinal flange extending downward from the outside surface thereof. The longitudinal flange is angled outward away from the main body of the cover to define an overhang about an exterior rim of the dump bed. The skeleton can have a pair of spaced apart transverse beams aligned with and defining the respective oppositely positioned tyne pockets.

In yet another aspect, a cover installation station is disclosed that has a first designated position for a first wheel chock for positioning of a vehicle having a dump bed, a pair of guide rails fixedly positioned in a parallel spaced apart arrangement to receive therebetween a vehicle or device having tynes and positioned parallel and offset from the first designated position for the first wheel chock, and any of the covers disclosed herein and including the pair of tyne pockets on one or both sides of the cover. The station also has a second designated position for a second wheel chock for positioning of the vehicle. The station can include a forklift or any other type of lifting device that has a pair of tynes configured to fit within a pair of the tyne pockets of the cover.

A further aspect disclosed herein is a system that includes a vehicle having a dump bed and a cover removably attached to the dump bed. The cover can be any of the embodiments disclosed herein. The dump bed has a stripe positioned on the driver side of the bed and/or the passenger side of the bed in alignment with one of each of the tyne pockets. The truck can be an on-road dump truck or an off-road dump truck.

Also disclosed herein are methods of installing any of the covers herein on the dump bed, in particular, those that have a pair of tyne pockets on one or both sides of the cover. The method includes providing one of the covers, inserting for tynes of a lifting machine into the pair of the tyne pockets of the cover, lifting the cover and positioning the cover on a dump bed, and attaching the cover to the dump bed. In one embodiment, attaching the cover to the dump bed includes inserting a pin in each aperture of a left post and aright post of the cover after the posts are seated in respective apertures in the dump bed. In another embodiment, attaching the cover to the dump bed includes connecting hinges of the cover to the dump bed and connecting a hydraulic arm of the cover to the dump bed and to a vehicle hydraulic system.

### BRIEF DESCRIPTION OF THE DRAWINGS

A better understanding of the features, advantages and principles of the present disclosure will be obtained by reference to the following detailed description that sets forth illustrative embodiments, examples of which are additionally illustrated in the accompanying drawings. In the drawings, like reference numbers indicate identical or functionally similar elements.

FIG. 1 is a driver's side view of a cover according to one embodiment sealingly seated on a dump bed of a Caterpillar brand Articulated Truck 740GC.

FIG. 2 is a rear, passenger side view of the truck of FIG. 1 with the tailgate up, thereby lifting the cover to dump a payload.

FIG. 3 is a passenger side view of the dump bed of the truck of FIG. 1 with the tailgate up, thereby lifting the cover to dump a payload.

FIG. 4 is a top perspective view of one embodiment of a skeleton of the cover.

FIG. 5 is a top perspective view of cover having a top fixed to the skeleton of FIG. 4.

FIG. 6 is a bottom view of the underside of the cover showing a portion of the skeleton.

FIG. 7 is a perspective view of the cover from the truck cap end showing the underside thereof.

FIG. 8 is an end perspective view of the rear end of the cover.

FIG. 9 is a bottom perspective view of the rear end of the cover.

FIG. 10 is a bottom perspective, enlarged view of the sealing material and flange extending along a side of the cover.

FIG. 11 is an enlarged view of a pin fastened to the vehicle and a post of the cover projecting through an aperture in the dump bed.

FIG. 12 is an enlarged view of the assembly of FIG. 11 with the pin inserted and fastened to the post of the cover.

FIG. 13 is a perspective view of a cover installation and removal station.

FIG. 14 is a passenger side perspective view of an embodiment of an installed cover having alignment stripes on the cover and dump bed.

FIG. 15 is a perspective view of a vehicle bed with another embodiment of a cover in the closed position.

FIG. 16 is a perspective view of the vehicle bed and cover of FIG. 15 in the open position.

FIG. 17 is a perspective view of a vehicle bed with third embodiment of a cover in the closed position.

FIG. 18 is a front perspective view of the vehicle bed of FIG. 17.

FIG. 19 is a driver side perspective view of the third embodiment with the cover in a fully open position.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

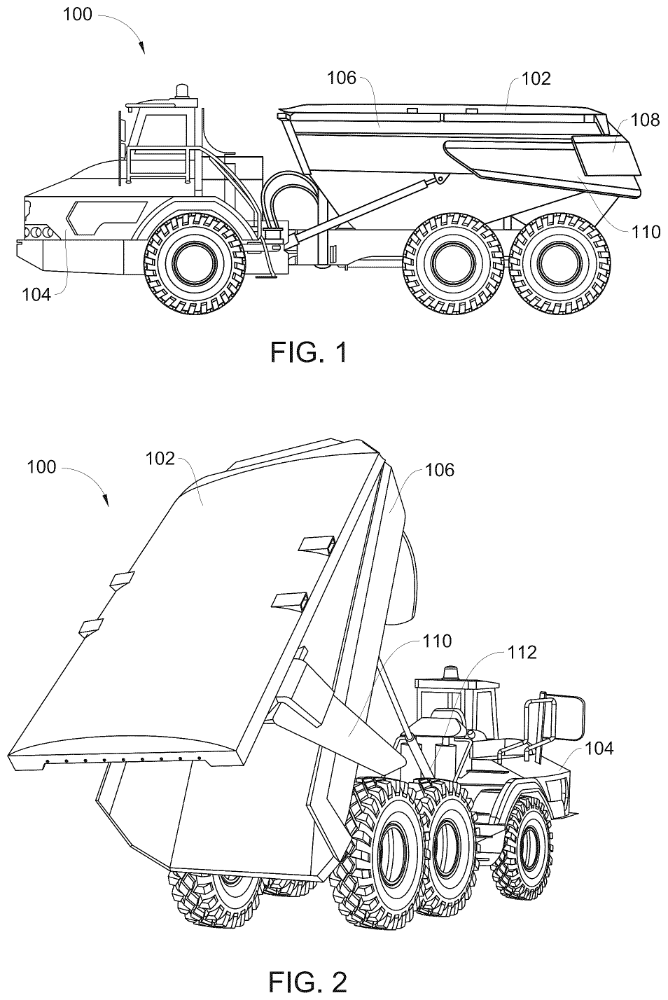

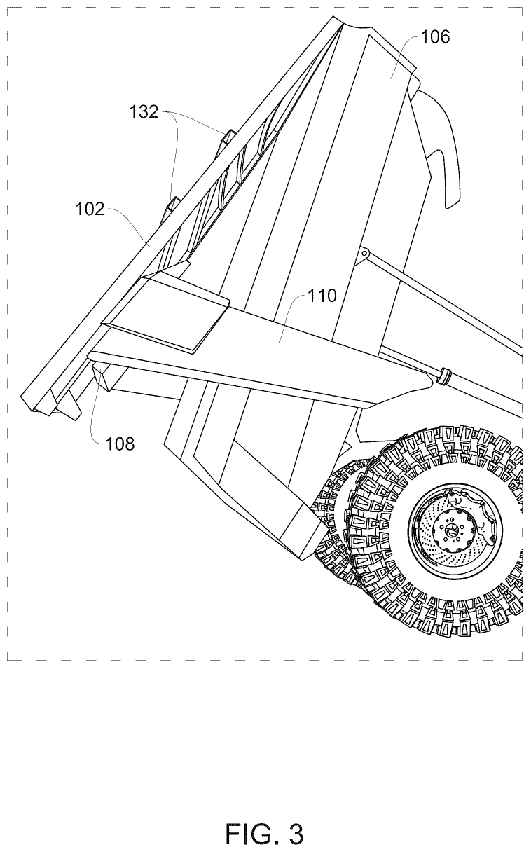

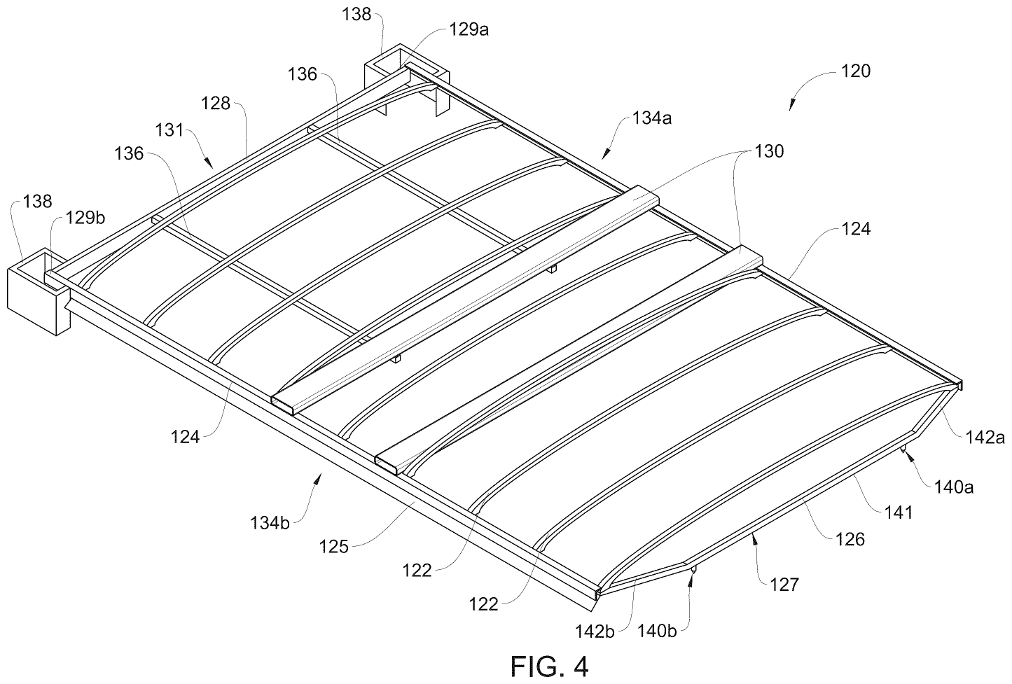

Referring now to FIGS. 1 to 3, a system 100 is shown that includes a cover 102 on a dump bed 106 of a vehicle 104, such as an articulated truck. Articulated trucks are available from manufacturers such as Caterpillar in various sizes, a 740GC rated for 36.3 tons, shown in the photographs, a 730 rated for 31 tons, a 745 rated for 45.2 tons, etc. The dump truck can also be an on-road truck, heavy duty or light duty, including but not limited to a Peterbilt 20 ton dump truck or a Kenworth 20 ton dump truck. The vehicle 104 has a dump bed 106, which has a tailgate 108 mounted to arms 110 (driver side arm shown in FIG. 1 and passenger side arm shown in FIG. 2) configured to rotate the tailgate 108 upward with the arms 110 as the head of the dump bed is pushed upward via a hydraulic system 112 to dump a payload.

The cover 102 is designed to be removed from the vehicle 104 or opened for loading of a payload. After loading is complete, the cover 102 is installed on the dump bed 106 or closed and safely secured thereto as described herein to prevent water/air from entering the dump bed. Therefore, all debris is contained in the dump bed 106 while in transit to a waste site. At the waste site the dump bed 106 can be dumped without removing the cover 102 because the cover is attached to the dump bed 106 in a manner that enable the tailgate of the dump bed to lift the rear of the cover 102 while the front of the cover 102 remains attached to the dump bed. As the dump bed 106 raises, the cover 102 will slide onto the tailgate 108 by using slide rails 136 (shown in FIG. 4) under the cover 102; therefore, creating space for the debris to exit the dump bed 106. After dumping is complete the bed is lowered back down as the dump bed is lowered and will automatically seal the dump bed again for the return trip.

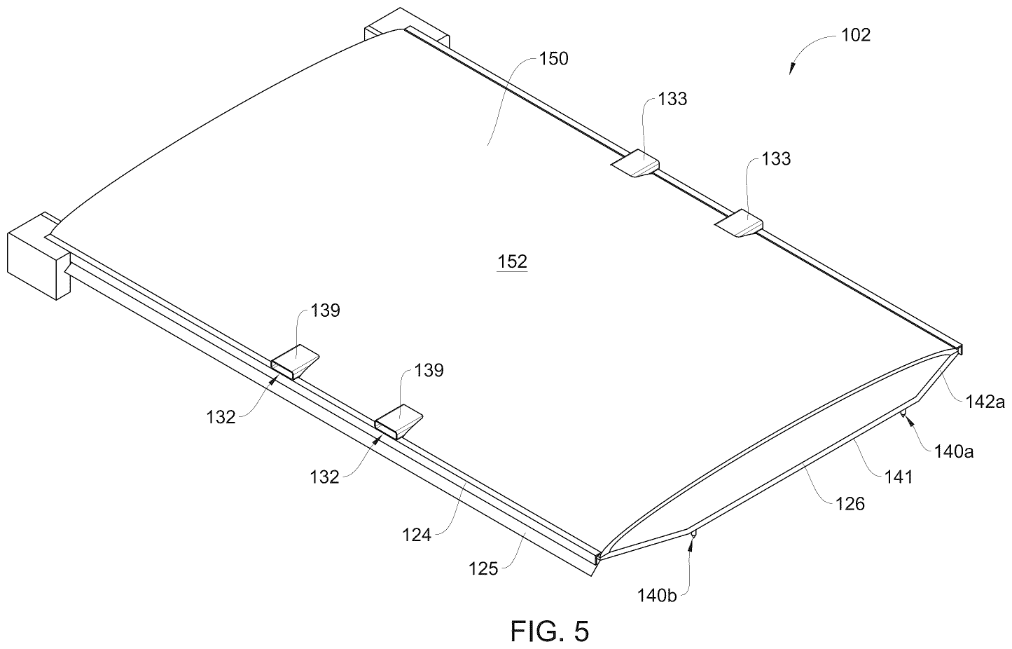

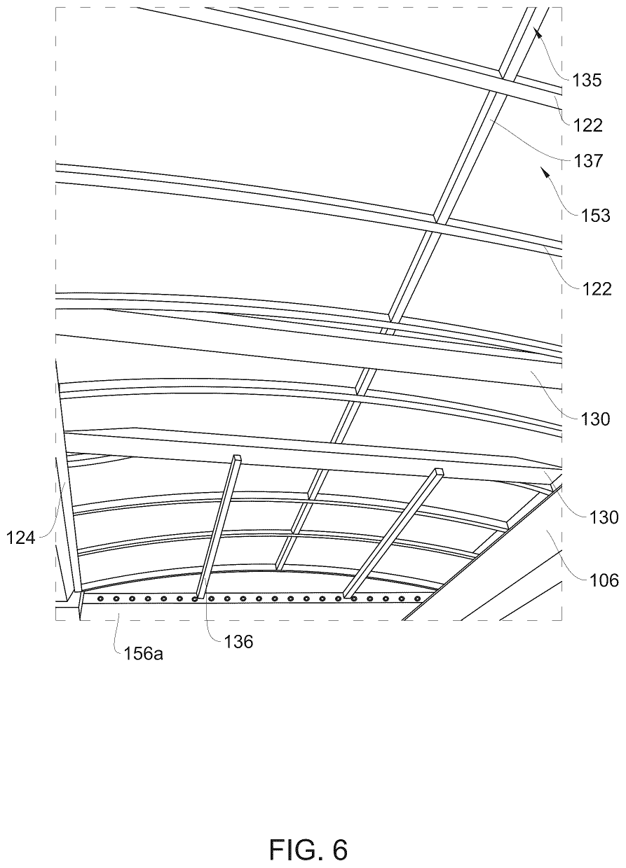

Referring now to FIGS. 4-5, the cover has a skeleton 120 comprising a plurality of spaced apart transverse ribs 122 extending between generally parallel longitudinal side beams 124, a head beam 126 and a tail beam 128, a pair of transverse beams 130 defining a pair of tyne pockets 132 at each of the sides 134a, 134b defined by the side beams, and one or more longitudinal rails 136 positioned and configured for a tailgate of the dump bed to slide under the skeleton 120 and lift the cover 102. Each of the transverse beams defines oppositely positioned tyne pockets 132, one at the terminal end 133 and the other at the opposite terminal end 139. The side beams 124 are spaced apart a distance to align with the elongate sides of the dump bed. A cover material, such as sheet metal, is connected to the skeleton 120 and defines a closed top surface 152 (and bottom surface 153, FIG. 6) with the terminal ends 133, 139 of each pair of the tyne pockets 132 exposed, as shown in FIG. 5. A scaling material 156 is connected to each of the side beams 124, head beam 126, and tail beam 128 to sealing engage surfaces of the dump bed, thereby sealingly enclosing any material deposited in the dump bed 106.

The tyne pockets 132 are configured to receive the tynes of a forklift capable of lifting the cover and seating the cover on a dump bed of the vehicle. The skeleton 120 and the cover 102 is primarily made of metal components to provide the desired strength and durability to the cover. The metal is typically steel but is not limited thereto. The metal can be any commercially available metal or metal alloy or any such materials herein after developed. The parallel longitudinal side beams 124 can be 2×2 inch square tubing. The transverse beans 130 can by 3×8 inch tubing. The ribs 122 and slide rails 136 are typically dimensionally smaller than the side beams. The skeleton 120 can include one or more elongate support beams 135 extending from the head beam 126 to the tail beam 128 or a plurality of support segments 137 extending between neighboring ribs 122 that collectively define the elongate support beam 135.

In some or all embodiments, the ribs 122 can be arcuate in shape, thereby configuring the cover 102 to be domed. The domed shape of the cover 102 provides additional volume to the dump bed to haul some extra payload and to eliminate the need to level off the payload therein.

Each of the longitudinal side beams 124 has a longitudinal flange 125 extending downward from the outside surface thereof. The longitudinal flange 125 is angled θ2 outward away from main body of the cover 102 to define an overhang about the exterior rim of the dump bed. The longitudinal rails can extend from the tail beam. The longitudinal rails 136 extend from the tail beam 128 toward the head beam 126 and terminate proximate a mid-region of the skeleton. Exterior corners 138 can be present at each end 129a, 129b of the tail beam 128. The exterior corners 138 can include a rubber material or other flexible or resilient material such as an elastomer. The head beam 126 comprises a left post 140a and a right post 104b.

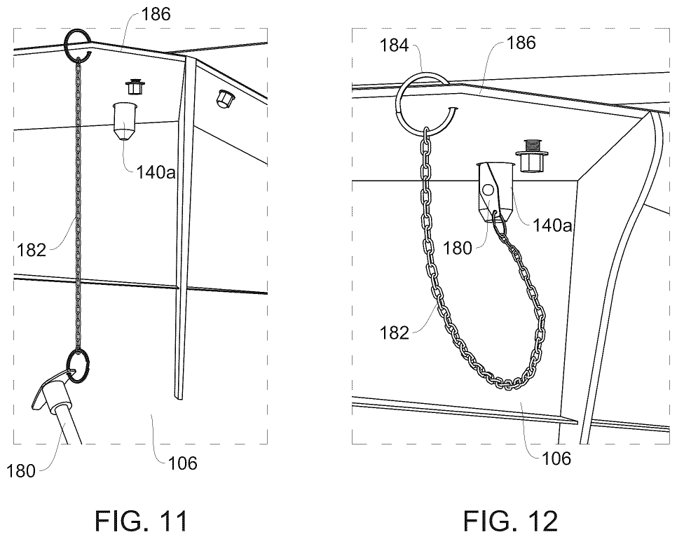

Referring to FIGS. 4, 5, 8, and 11-12, the left and right posts 140a, 140b protrude from the underside surface of the head beam 126 in a downward direction. Each of the left post 140a and the right post 140b are configured to seat in an aperture in the head of the dump bed (see FIGS. 11 and 12) and each has a transverse bore configured to receive a removable pin 180, which in FIGS. 11 and 12 is connected to the dump bed by a chain 182 connected to a ring 184 that is looped through another aperture in the dump bed header 186. The pins 180 secure the cover to the dump bed 106 while allowing some movement of the cover 102 during dumping of a payload, thereby enabling the rear of the cover to be lifted by the tailgate of the dump bed. Each pin 180 is removed from their respective post 140a, 140b to enable the cover to be lifted off the dump bed 106 and removed so that the dump bed can be filled with a payload.

As best seen in FIG. 5, the head beam 126 of the cover 102 has a generally planar central section 141 that terminates with upward angled ends segments 142a and 142b. The upward angled ends 142a, 142b each form a junction with their respective side beams 124. The left and right posts 140a, 140b are on the central section 141, proximate the ends thereof and the junction to the upward angled end segments 142a, 142b.

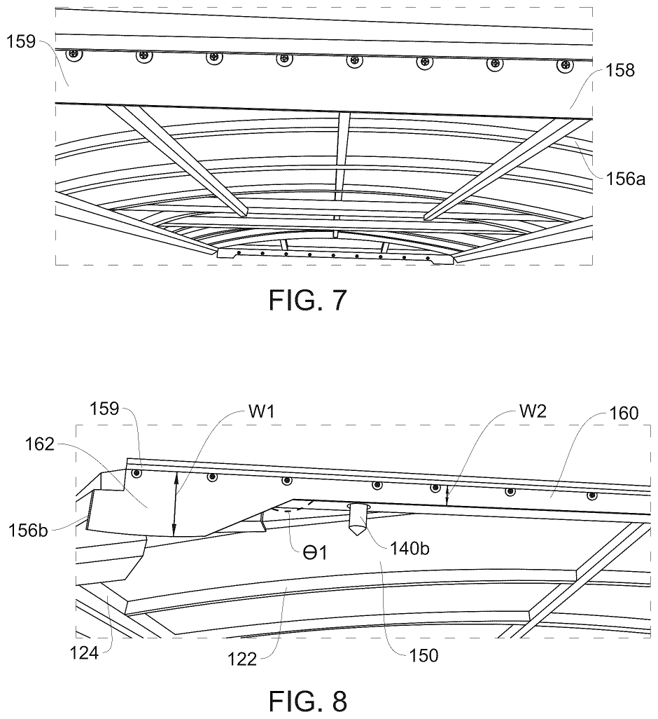

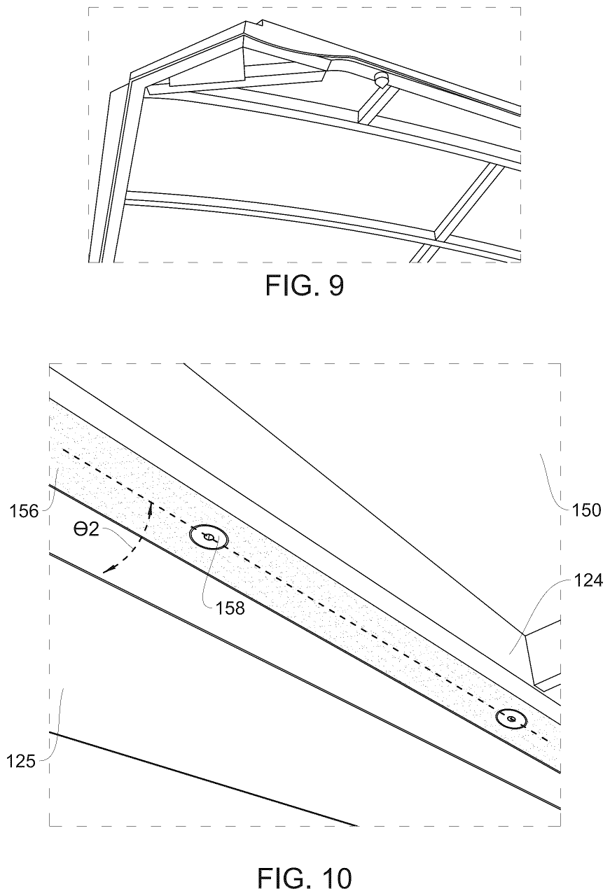

With reference to FIGS. 6-10, in other embodiments, each beam 124, 126, 128 of the skeleton has its own elongate piece of sealing material 156. The sealing material 156a at the tail beam, shown in FIG. 7, is mounted to the rear-facing surface 131 thereof and it hangs down therefrom like a curtain. The sealing material 156a is typically of a single width continuous over its length. The upper portion of the sealing material 156a and even a portion of the fasteners 158 may be covered by a protective member 159, such as metal strip. Turning now to FIG. 8, the sealing material 156b at the head beam 126 is mounted to the cab-facing surface 127 thereof and it hangs down therefrom like a curtain. The sealing material 156b can be wider at the ends (width W1) than at a middle section (width W2). The transition from the middle section 160 to the ends can be an obtuse angle θ1 transitioning to each end portion 162.

As best seen in FIG. 10, the sealing material may be a rubber or other elastomer. Each sealing material 156a-156c may be connected to the respective side beam by a fastener 158.

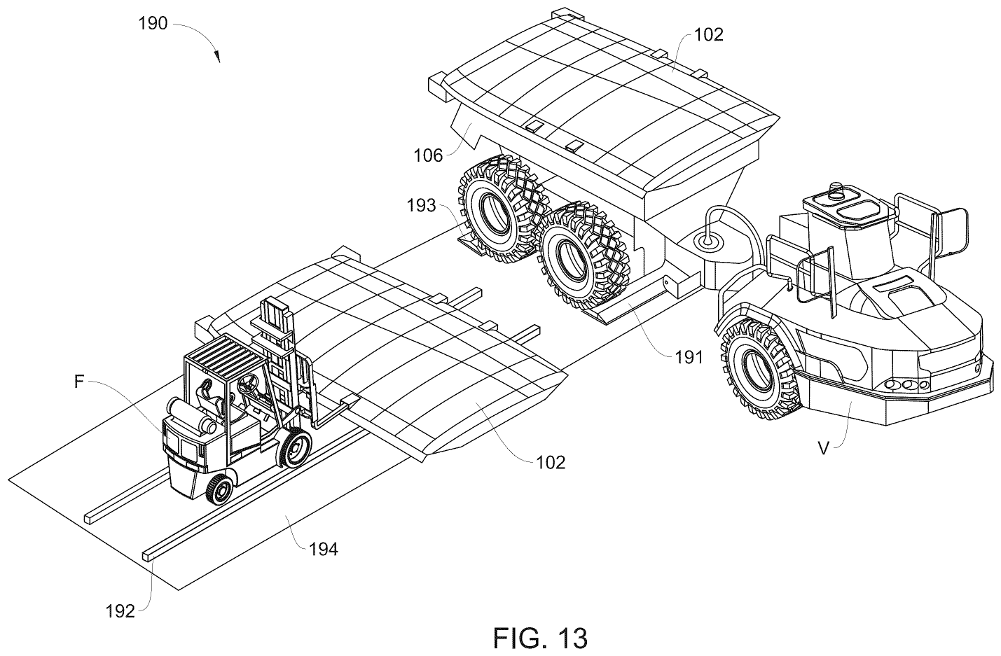

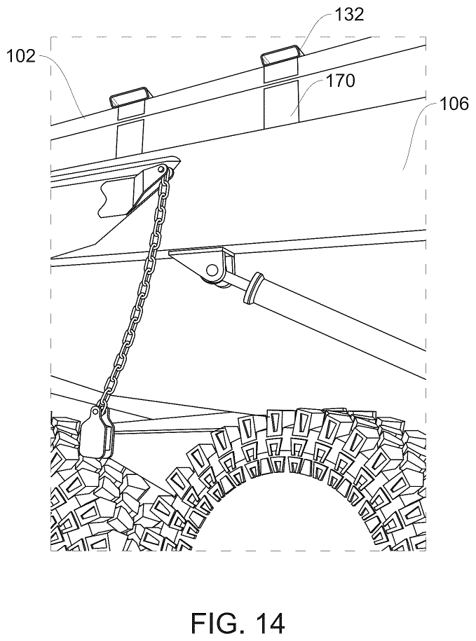

Referring to FIG. 13, a cover installation station 190 is provided that has a first designated position for a first wheel chock 191 for positioning of a vehicle V having a dump bed 106, a pair of guide rails 192 fixedly positioned in a parallel spaced apart arrangement to receive a forklift F therebetween and positioned parallel and offset from the first designated position for the first wheel chock 191, and the cover 102 from any of the embodiments described herein. The station 190 can have a second designated position for a second wheel chock 193 for positioning of the vehicle and a level pad 194 upon which the wheel chocks and rails are set. Alternately, the truck can include deployable wheel chocks, such as is taught in U.S. Pat. No. 10,131,328 and U.S. 2017/0259792. The rails 192 may be fixedly attached or removably attached (i.e., adjustable to the width of the wheels of the various forklifts available, to the level pad 194 whereas the wheel chocks are removably attached thereto. Station 190 has rails 192 positioned relative to the first designated position for the first wheel chock 191 to align the tynes of the forklift F with the tyne pockets 132 of the cover 102 for removal of a cover from a dump bed. Referring now to FIG. 14, the dump bed can include stripes 170 or other indicia positioned on the driver side of the bed and/or the passenger side of the dump bed 106 in alignment, one each, with a pocket of the pair of tyne pockets 132. While a forklift is shown in the figure, any type of lifting device that has tynes configured to fit in the tyne pockets of the cover can be used at the installation station. The lifting device can be a hydraulic movable arm or the like that has tynes.

A method of installing a cover on a dump bed is disclosed herein. The method includes providing a cover from any of the embodiments described herein, inserting fork truck tynes into a pair of the tyne pockets and lifting and positioning the cover on a dump bed, and attaching the cover to the dump bed. The cover can include connecting pins and the method thereby includes inserting a pin in each aperture of the left post and the right post of the cover after it is seated in respective apertures in the dump bed.

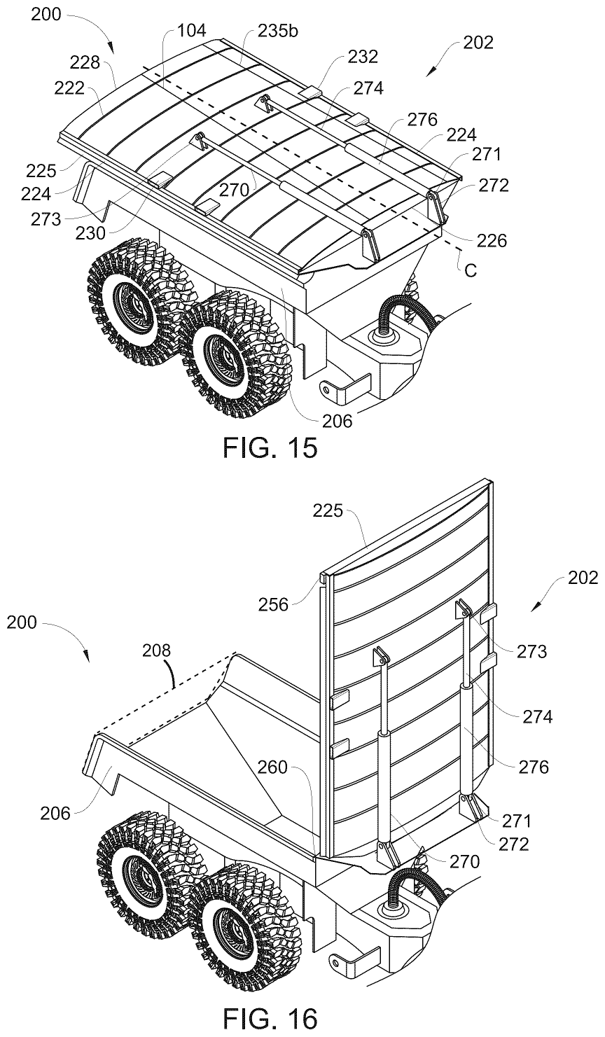

Turning now to FIGS. 15 and 16, a system 200 is shown that includes a cover 202 on a dump bed 206, such as for an articulated truck. The dump bed 206 can have a tailgate 208, represented by a dashed box in FIG. 16. The cover 202 has a skeleton 220 generally similar to the one described for the other embodiments herein. Like or similar parts will have the same number but being in the 200s. The cover 202 has a plurality of spaced apart transverse ribs 222 extending between generally parallel longitudinal side beams 224, comprising a head beam 226 and a tail beam 228, comprising a pair of transverse beams 230 defining a pair of tyne pockets 232 at each of the sides defined by the side beams 224. The skeleton 220, optionally, includes, one or more longitudinal rails positioned and configured for a tailgate of the dump bed to slide under the skeleton 220 and lift the cover 202, as described in detail for the prior embodiments. The side beams 224 are spaced apart a distance to align with the elongate sides of the dump bed. The skeleton 220 can include one or more elongate support beams 235 extending from the head beam 226 to the tail beam 228. A first elongate support 235a can be most proximate the central longitudinal axis C and is aligned therewith, parallel thereto, or oriented at an angle relative thereto. A secondary elongate support(s) 235b is proximate one or each of the side beams 224, and is parallel thereto, or oriented at an angle relative thereto.

The cover 202 has a top surface 250 is formed over and connected to the skeleton 220 and defines a closed top with the terminal ends of each pair of the tyne pockets 232 exposed. The cover 202 has scaling material 256 connected to each of the side beams 224, head beam 226, and tail beam 228 configured to sealing engage surfaces of the dump bed. Each of the longitudinal side beams 224 can have a longitudinal flange 225 extending downward from the outside surface thereof. The sealing material 256 is as described above relative to the other embodiments. The longitudinal flange 225 is angled, as described above with respect to FIG. 10, outward away from main body of the cover 202 to define an overhang about the exterior rim of the dump bed 206.

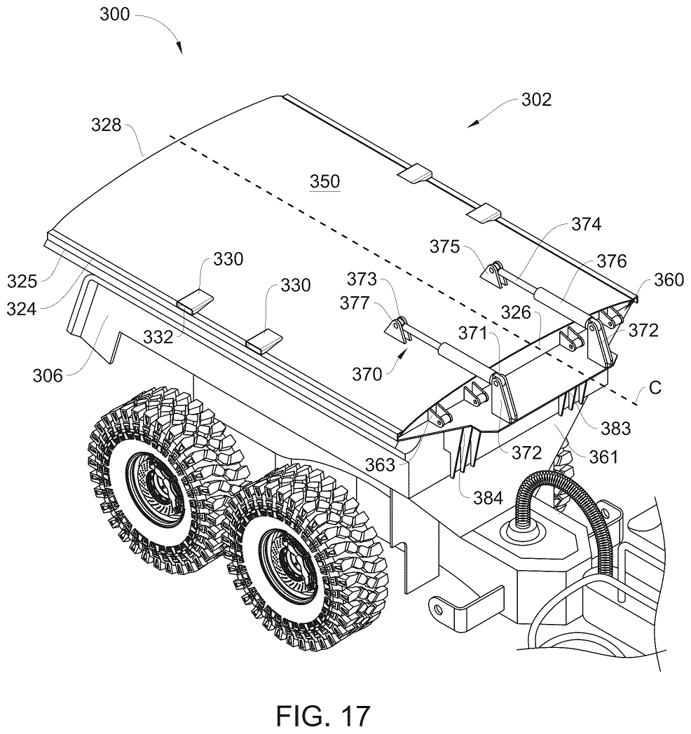

Still referring to FIGS. 15 and 16, cover 202 has a hinged connection 260 to the dump bed 206 at the front end thereof and is operatively connected to the front of the dump bed by a pair of hydraulic arms 270. The front of the dump bed includes an anchor 272 for each hydraulic arm 270, where a proximal end 271 of the respective hydraulic arm 270 is connected to the anchor and a distal end 273 thereof is connected to the cover 202. In operation, the hydraulic arms extend to move the cover into the closed position of FIG. 15 and retract to move the cover into the open position of FIG. 17. The distal end 273 comprises a movable portion 274 of the arm and the proximal end comprises a fixed portion 276 of the arm, such that the distal end 273 is movable via the hydraulics relative to the fixed portion.

The distal end 273 of each hydraulic arm 270 may be connected to the cover at a distance that is at or greater than halfway from the head beam 226 toward the tail beam 228.

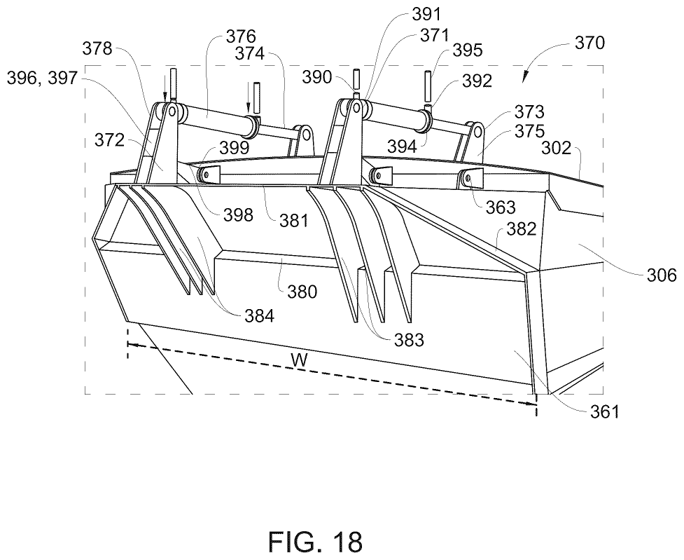

Turning now to FIGS. 17-18, a system 300 is shown that includes a cover 302 on a dump bed 306, such as for an articulated truck. The dump bed 306 can have a tailgate (not shown in FIG. 17, see FIG. 1). The cover 302 has a skeleton the same as or similar to the ones described for the other embodiments herein. Like or similar parts will have the same number but being in the 300s.

The cover 302 has a plurality of spaced apart transverse ribs extending between generally parallel longitudinal side beams 324, comprising a head beam 326 and a tail beam 328, comprising a pair of transverse beams 330 defining a pair of tyne pockets 332 at each of the sides defined by the side beams 324. The skeleton, optionally, includes, one or more longitudinal rails positioned and configured for a tailgate of the dump bed to slide under, as described in detail for the prior embodiments. The side beams 324 are spaced apart a distance to align with the elongate sides of the dump bed 306. The skeleton can include one or more elongate support beams or support segments that collectively define the elongate support beam as shown in FIG. 6 extending from the head beam 326 to the tail beam 328. A first elongate support beam can be most proximate the central longitudinal axis C, aligned therewith, parallel thereto, or oriented at an angle relative thereto. Secondary elongate supports are proximate one or each of the side beams 324, and is parallel thereto, or oriented at an angle relative thereto.

The cover 302 has a top surface 350 formed over and connected to the skeleton and defines a closed top with the terminal ends of each pair of tyne pockets 332 exposed. The cover 302 has scaling material connected to each of the side beams 234, head beam 326, and tail beam 328, which is configured to sealing engage surfaces of the dump bed, as shown and described with respect to FIG. 10. Each of the longitudinal side beams 324 can have a longitudinal flange 325 extending downward from the outside surface thereof. The scaling material is as described above relative to the other embodiments. The longitudinal flange 325 is angled, as described above with respect to FIG. 10, outward away from main body of the cover 302 to define an overhang about the exterior rim of the dump bed.

Still referring to FIGS. 17-18, cover 302 has a hinged connection 360 (accomplished by a plurality of hinges 363, shown in the figures as being four hinges) to the dump bed 306 at the front end 361 thereof and is operatively connected to the front of the dump bed by a pair of hydraulic arms 370. The front end 361 of the dump bed 306 includes a shoulder 380 extending across the width W thereof, a shelf 381 extending across a central part of the width at a position above the shelf 380, end extensions 382 from each end of the shelf 381 angled down and outward to terminate at respective ends of the shoulder 380, a first set of fins 383 extending vertically from an under side of the shelf 381 at a position proximate and/or under an anchor 372 to a first hydraulic arm, and a second set of fins 384 extending vertically from an under side of the shelf 381 at a position proximate and/or under an anchor 372 to a second hydraulic arm. The first and second set of fins 383, 384 each extend from the shelf, adjoin the shoulder 380, and extending beyond the shoulder 380.

A proximal end 371 of the respective hydraulic arm 370 is connected to a respective anchor 372 and a distal end 373 of the respective hydraulic arm 370 is connected to the cover 302 via a second anchor 375. The hydraulic arm 370 terminates at each end 371, 373 with either an eyelet or a clevis connector and the anchor 372 has the opposite mating configuration for receiving a pin 377 therethrough to define a pivot point. The hydraulic arm 370 has a piston rod 374 (movable portion) operatively connected to a cylinder tube 376 (fixed portion, but pivotable at its proximal end, the one connected to anchor 372). With reference to FIG. 18, the cylinder tuber 376 includes an extend flow port 390 at a base end 391 of the cylinder and a retract flow port 392 at the rod receiving end 393 of thereof, which are respectively operatively couplable to or are coupled to a hydraulic systems of the vehicle via hoses/conduits 395.

The anchors 372, 375 are generally triangular and the respective proximal end 371 and distal end 373 of the hydraulic arm 370 are connected at the apex thereof, which forms a pivot point for operative movement of the hydraulic arm. The anchors 372 are each fixedly attached to the shelf 381 of the front end 361 of the dump bed 306. Each anchor 372 has can include a reinforcing member 396 mounted through the center of the anchor. The reinforcing member 396 can terminate with an end plate 397 fixed to a front face 378 of the anchor and have an arm 398 extending therefrom through the anchor 372 at an angle such that the opposing end 399 from the end plate 397 is fixed mounted into a hinge 363 or proximate a hinge 363.

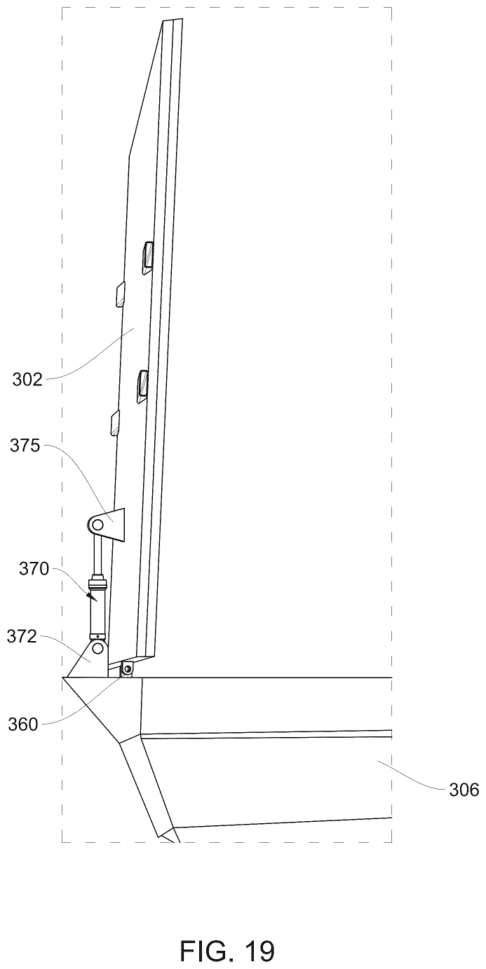

In operation, the hydraulic arms 370 extend to move the cover 302 into the closed position of FIGS. 17 and 18 by pumping hydraulic fluid into the cylinder tube 376 via the extend flow port 390 shown in FIG. 18 and the hose 395 connected thereto and retract to move the cover into the open position of FIG. 19 by drawing hydraulic fluid out of the cylinder tube 376 via the retract flow port 392 and its respective hose connected thereto.

The cover and the systems disclosed herein minimize labor and more importantly, seals debris, such as hazardous materials, within the dump bed during transport.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.” It will be understood that although the terms “first,” “second,” “third,” etc. may be used herein to describe various layers, elements, components, regions, or sections without referring to any particular order or sequence of events. These terms are merely used to distinguish one layer, element, component, region or section from another layer, element, component, region, or section. A first layer, element, component, region, or section as described herein could be referred to as a second layer, element, component, region, or section without departing from the teachings of the present disclosure. As used herein, the term “or” is used inclusively to refer items in the alternative and in combination.

Embodiments of the present disclosure have been shown and described as set forth herein and are provided by way of example only. One of ordinary skill in the art will recognize numerous adaptations, changes, variations, and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A cover for a dump bed of a vehicle, the cover comprising:
a skeleton comprising longitudinal side beams having a transverse rib extending therebetween, a head beam, a tail beam, and a pair of tyne pockets at one or both of the sides of the skeleton, wherein the longitudinal side beams are spaced apart a distance to align with the elongate sides of a dump bed;
a cover material connected to the skeleton and defining a closed surface with the terminal ends of the pair of the tyne pockets exposed; and
a sealing material connected to each of the longitudinal side beams, the head beam, and the tail beam; wherein the sealing material is configured to sealingly engage surfaces of the dump bed.

2. The cover of claim 1, wherein each of the longitudinal side beams has a longitudinal flange extending downward from an outside surface thereof.

3. The cover of claim 2, wherein the longitudinal flange is angled (02) outward away from the skeleton to define an overhang about an exterior rim of the dump bed.

4. The cover of claim 1, further comprising exterior corners at each end of the tail beam.

5. The cover of claim 1, wherein the head beam comprises a left post and a right post.

6. The cover of claim 1, wherein the skeleton further comprises a pair of spaced apart transverse beams aligned with and defining the one or both pairs of tyne pockets.

7. The cover of claim 1, wherein the skeleton further comprises one or more longitudinal rails proximate the tail beam and configured for a tailgate of the dump bed to slide thereagainst under the skeleton to lift the cover.

8. The cover of claim 7, wherein the longitudinal rails extend from the tail beam.

9. The cover of claim 1, wherein the cover further comprises one or more hinges configured to connect to the dump bed and a hydraulic arm connected to the cover and having a free end configured to be anchored to the dump bed and configured to hydraulically connect to a vehicle hydraulic system; wherein the hydraulic arm is configured to operatively open and close the cover relative to the dump bed of the vehicle.

10. A cover for a dump bed of a vehicle, the cover comprising:
a skeleton comprising side beams having a transverse rib extending therebetween, a head beam, a tail beam, wherein the side beams are spaced apart a distance to align with the elongate sides of a dump bed;
a cover material connected to the skeleton and defining a closed surface thereof;
one or more hinges configured to connect to the dump bed;
a hydraulic arm connected to the cover and having a free end configured to be anchored to the dump bed and configured to hydraulically connect to a vehicle hydraulic system; wherein the hydraulic arm is configured to operatively open and close the cover relative to the dump bed of the vehicle; and
a sealing material connected to each of the side beams, the head beam, and the tail beam; wherein the sealing material is configured to sealingly engage surfaces of the dump bed.

11. The cover of claim 10, wherein the skeleton further comprises a pair of spaced apart transverse beams aligned with and defining respective oppositely positioned tyne pockets.

12. The cover of claim 10, wherein each of the longitudinal side beams has a longitudinal flange extending downward from the outside surface thereof.

13. The cover of claim 12, wherein the longitudinal flange is angled (02) outward away from a main body of the cover to define an overhang about an exterior rim of the dump bed.

14. A cover installation station comprising:
a first designated position for a first wheel chock for positioning of a vehicle having a dump bed;
a pair of guide rails fixedly positioned in a parallel spaced apart arrangement to receive therebetween a vehicle or device having tynes and positioned parallel and offset from the first designated position for the first wheel chock; and
a cover comprising:
a skeleton comprising longitudinal side beams having a transverse rib extending therebetween, a head beam, a tail beam, and a pair of tyne pockets at one or both of the sides of the skeleton, wherein the longitudinal side beams are spaced apart a distance to align with the elongate sides of a dump bed;
a cover material connected to the skeleton and defining a closed surface with the terminal ends of the pair of the tyne pockets exposed; and
a sealing material connected to each of the longitudinal side beams, the head beam, and the tail beam; wherein the sealing material is configured to sealingly engage surfaces of the dump bed.

15. The cover installation station of claim 14, further comprising a second designated position for a second wheel chock for positioning of the vehicle.

16. The cover installation station of claim 14, further comprising a forklift having tynes configured to fit within a pair of the tyne pockets of the cover.

17. A system comprising a vehicle having a dump bed and a cover removably attached to the dump bed, the cover comprising:
a skeleton comprising side beams having a transverse rib extending therebetween, a head beam, a tail beam, wherein the side beams are spaced apart a distance to align with the elongate sides of a dump bed;
a cover material connected to the skeleton and defining a closed surface thereof;
one or more hinges configured to connect to the dump bed;
a hydraulic arm connected to the cover and having a free end configured to be anchored to the dump bed and configured to hydraulically connect to a vehicle hydraulic system; wherein the hydraulic arm is configured to operatively open and close the cover relative to the dump bed of the vehicle; and
a sealing material connected to each of the side beams, the head beam, and the tail beam and configured to sealing engage surfaces of the dump bed.

18. The system of claim 17, wherein the dump bed has a stripe positioned on the driver side of the bed and/or the passenger side of the bed in alignment with one of each of the tyne pockets.

19. The system of claim 17, wherein the truck is an on-road dump truck or an off-road dump truck.
